(19) United States
(12) Patent Application Publication
(10) Pub. No.: US 2020/0378513 A1
(43) Pub. Date: Dec. 3, 2020

(54) Heated Faucet Cover

(71) Applicant: Robert Kowalski, Allen, TX (US)

(72) Inventor: Robert Kowalski, Allen, TX (US)

(21) Appl. No.: 16/882,998

(22) Filed: May 26, 2020

Related U.S. Application Data
(60) Provisional application No. 62/855,219, filed on May 31, 2019.

(51) Int. Cl. F16K 27/12; E03B 7/12; F16K 49/00

(52) U.S. Cl. CPC F16K 27/12; F16K 49/002; E03B 7/12

(57) ABSTRACT

A heated faucet cover configured to insulate and protect exterior faucets is disclosed. The cover is configured to provide heat to the faucet when the temperature lowered below a predetermined temperature. The faucet cover includes a housing with an outer shell. The cover further includes a heating system and a control device. The heating system includes one or more heat sources, for example, incandescent bulbs. The heat sources are securely positioned within the cavity of the housing and mounted on bases of the cover, which are electrically connected to the power supply via a power cord. The control device is a thermostatic control element, configured to control the operation of the heat sources. The control device activates the heat sources when the predetermined ambient temperature falls below 35° F. and shuts off when the predetermined ambient temperature is above 45° F., thereby preventing the faucets from freezing in cold weather conditions.

### CROSS-REFERENCE TO RELATED APPLICATIONS

This application claims the benefit of U.S. Provisional Application No. 62/855,219, filed on May 30, 2019.

### TECHNICAL FIELD

The present invention generally relates to a device for protecting a faucet from freezing in cold weather conditions. More specifically, the present invention relates to a faucet cover used to insulate and protect exterior water faucets from freezing in cold weather conditions.

### BACKGROUND

Freezing weather can cause the water within pipes and/or a faucet mounted inside the house wall to become frozen and burst, thus causing substantial damages. Water encroaching into structures from broken or damaged water lines or pipes can cause enormous amounts of damage. The damage may affect the entire structure or just be a minor annoyance depending on the type of plumbing system that is installed.

Insulation of homes and business with interior plumbing systems is significantly reduces the possibility of freezing water pipes. However, the water pipes will eventually become cold soaked if left for a long enough period in freezing temperatures. Any type of insulation that can protect pipes should be as tight as possible to prevent cold air from seeping into the interior of the insulation where it contacts the pipe material. Eventually, the insulation will absorb the cold and reach the temperature as the outside air. After the insulation has been penetrated, the water pipes can only hold off the plunge in temperature for so long as well as the water contained within. Once the water begins to freeze, the tremendous force exerted by the conversion of water into its solid form of ice can break the pipe. Obviously when the inevitable rise in temperature begins to melt or thaw the ice and water damage will result unless the pipe has been repaired or the water pressure has been shut-off or eliminated.

A common type of insulation for an outdoor plumbing faucet is a Styrofoam cup that is designed to fit over the faucet and be drawn snug against the exterior wall to prevent air leaks. The exterior faucet is a particularly vulnerable plumbing location due to its exposure to the outside. Due to its exposed position, the exposed faucet is usually installed as a freeze-proof faucet where the valve to shut off the water and recessed into the wall where the temperature is warmer due to the proximity of the heated interior of the structure. Regardless of this feature or in instances where the freeze-proof faucet is not present many people still employ the insulated faucet cover or cup over exterior faucets.

The insulated faucet covers or cup is of limited value however, since the cover will eventually reach the same temperature as the outside air in a brief period of time. The insulated faucet cover is unheated, and without a heat source, it will become like any other object left out in the cold. It will reach the temperature of the air shortly after installation rendering so it is useless as protection for the outside faucet from freezing. Many people purchase insulated faucet covers assuming that they will protect their outdoor faucets.

The temperature drops below the freezing point in climates, the outside or exterior faucets are prone to freezing solid and bursting the plumbing associated with the faucets. This can cause small floods of water in the home or can cause thousands of dollars of damage if not caught in time. The same issue can occur with the existing frost-free exterior faucets. The insulated covers help slightly, but the thermal transfer by the faucet into the insulated cover is not sufficient to prevent freezing and causing damage.

Therefore, there is a need for a faucet cover with a heat source for protecting the outside faucet from freezing during long cold winters. There is also a need to provide a faucet cover for providing sufficient heat for the faucet above freezing temperatures on a consistent basis. Further, there is also a need to provide an inexpensive faucet cover and easily install to the faucet without an effort.

### SUMMARY

The present invention generally discloses a device for protecting a faucet from freezing in cold weather conditions. Further, the present invention discloses a faucet cover used to insulate and protect exterior water faucets from freezing in cold weather conditions.

In one embodiment, the cover is configured to provide heat to the faucet when the temperature lowered below a predetermined temperature, thereby preventing freezing in the cold weather condition. The cover could simply and removably mounted over the external faucet without any effort. In a preferred embodiment, the cover is made of a material, but not limited to, a polystyrene material. In one embodiment, the cover is made of a material, but not limited to, plastic. The cover is a thermally insulating box.

In one embodiment, the cover comprises a housing. The housing includes side walls and an end wall to form a cavity with an open end. In one embodiment, the cavity is configured to receive the faucet via the open end. The faucet is a conventional water faucet which is mounted to an outside wall of a building. In one embodiment, the cover further includes an outer shell. The outer shell is made of a material, but not limited to, plastic. The outer shell is configured to enhance the durability and extend the product life for several cold weather conditions to minimize expense. In a preferred embodiment, the outer shell is a blow or rotationally molded from polypropylene plastic. In one embodiment, an insulating foam is formed inside the outer shell using, but not limited to, a molded polystyrene insulation and a form-in-place (FIP) polystyrene plastic.

In one embodiment, the cover further comprises a connecting member. The cover is configured to easily secure to the faucet via the connecting member. In one embodiment, the connecting member is a threaded rod with a hook. In one embodiment, one end of the threaded rod includes a plurality of threads and another end includes the hook. The one end of the threaded rod is threaded to, but not limited to, 5-40 threads to accept the commercially available, a nylon wingnut. The other end of the threaded rod is bent around, but not limited to, 1.0″ mandrel. In one embodiment, the threaded rod includes a compressible rubber washer and a flat stainless-steel washer. The rubber washer makes a weather-resistant seal against the outer plastic shell and the flat stainless-steel washer. In one embodiment, one end of the connecting member is positioned within the cavity and inserted via an opening of the end wall and another end is securely connected to the faucet via the hook. The user could tighten the connecting member to the faucet using a fastener, for example, a bolt or a nylon wingnut.

In one embodiment, the cover further includes a heating system. In one embodiment, the heating system is activated automatically when the predetermined ambient temperature falls below 35° F. and shuts off when the predetermined ambient temperature is above 45° F. In one embodiment, the heating system includes at least two heat sources, for example, incandescent bulbs. The heat sources are securely positioned within the cavity of the cover and mounted on bases of the cover. The heat sources are electrically connected to the power supply via a power cord with a polarized plug. In one embodiment, the cover is operated at 120 VAC using 2-wire, 16-gauge wires wrapped with heavy-duty, exterior PVC jacketed extension cord.

In one embodiment, the cover further comprises a control element/device. In one embodiment, the control device is a thermostatic control element and a temperature sensor. In one embodiment, the control device is configured to control the operation of the heat sources positioned within the cavity of the cover. In one embodiment, the cover is operated using 120 VAC power from household mains. The control device or thermostatic switch may be of many different designs. The control device activates the heat sources when the predetermined ambient temperature falls below at 35° F. and turn off heat sources when the predetermined ambient temperature at 45° F., thereby preventing the faucets from freezing in cold weather conditions.

In one embodiment, the cover further comprises one or more apertures at, but not limited to, the side walls and the end wall. The apertures are molded and are sealed for protecting the faucet from freezing in cold weather conditions. The cover provides space to make up all the connections. In one embodiment, the cover further includes a foam seal that is adhesively bonded to the bottom surface of the cover. The cover prevents water leaks inside the cavity to protect the heat sources and the connections from damages and in harsh conditions.

Other objects. features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a perspective view of a heated faucet cover assembled to a faucet in an embodiment of the present invention.

FIG. 2 shows an assembly of the heated faucet cover in one embodiment of the present invention.

FIG. 3 shows a sectional view of the heated faucet cover assembled to the faucet in one embodiment of the present invention.

FIG. 4 shows a bottom view of the heated faucet cover in one embodiment of the present invention.

FIG. 5 shows a side view of a heat source, for example, the incandescent bulb in one embodiment of the present invention.

FIG. 6 shows a side view of a connecting member of the heated faucet cover in one embodiment of the present invention.

FIG. 7 shows a side view of the heated faucet cover with an outer shell in one embodiment of the present invention.

FIG. 8 shows an enlarged view of the outer shell of the heated faucet cover in one embodiment of the present invention.

FIG. 9 shows a top view of the heated faucet cover provided with apertures and a power cord in one embodiment of the present invention.

### SPECIFICATION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

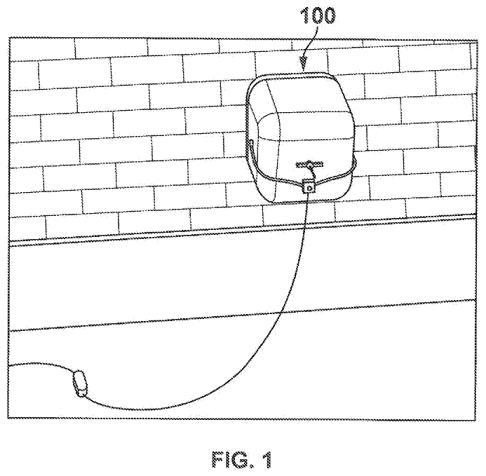

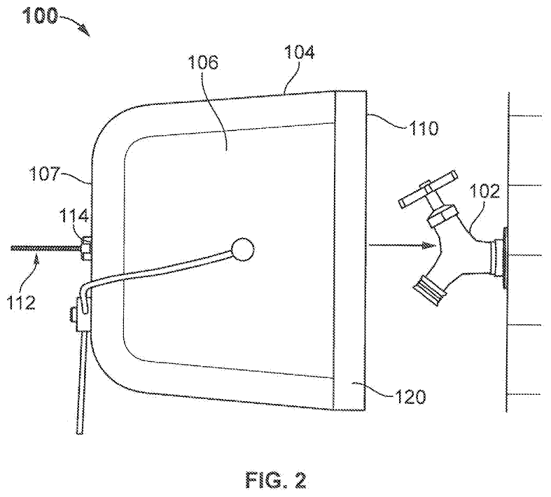

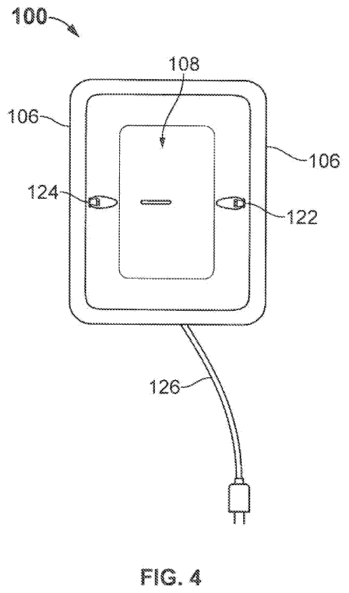

Referring to FIG. 1, a heated faucet cover 100 used to cover an external faucet 102 is disclosed. In one embodiment, the cover 100 is configured to insulate and protect an exterior water faucet from freezing in cold weather conditions. The cover 100 could simply and removably mounted over the faucet 102 (shown in FIG. 2) without any effort. In a preferred embodiment, the cover 100 is made of a material, but not limited to, a polystyrene material. In one embodiment, the cover 100 is made of a material, but not limited to, plastic. In one embodiment, the cover 100 is further configured to provide heat to the faucet 102 when the temperature lowered below a predetermined temperature, thereby preventing freezing in the cold weather condition. In one embodiment, the cover 100 includes a heating system. The heating system is configured to provide sufficient heat for the faucet 102 in cold weather conditions. In one embodiment, the heating system is configured to connect to a power supply via a wire or an extension cord 126 (shown in FIG. 4). In one embodiment, the heating system is activated automatically when the predetermined ambient temperature falls below 35° F. and shuts off when the predetermined ambient temperature is above 45° F. thereby preventing the faucet 102 from freezing in cold weather conditions. The cover 100 assures the user that the faucet 102 will stay warm and safe from freezing in the coldest temperatures. In one embodiment, the cover 100 could be adapted to existing faucet covers for a very economical solution to the danger of outdoor faucets freezing and causing damage and property loss for homeowners and business owners. The cover 100 is easy to install, easy to maintain, and easy to remove and store until the next season. In one embodiment, the cover 100 is of a dome shaped structure. The cover 100 is a thermally insulating box.

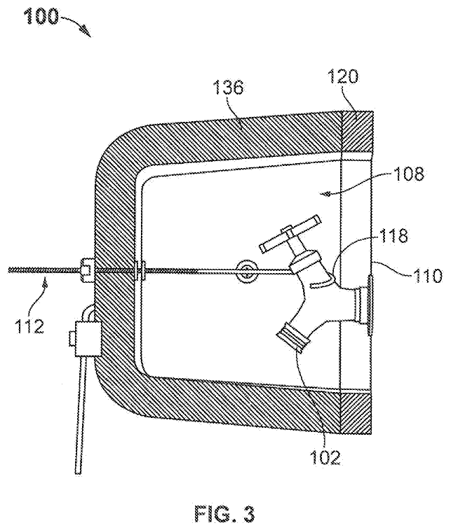

Referring to FIG. 2, the cover 100 is assembling to the faucet 102 is disclosed. In one embodiment, the cover 100 comprises a housing 104. The housing 104 includes side walls 106 and an end wall 107 to form a cavity 108 (shown in FIG. 3) with an open end 110. In one embodiment, the cavity 108 is configured to receive the faucet 102 via the open end 110. The faucet 102 is a conventional water faucet which is mounted to an outside wall of a building. In one embodiment, the cover 100 further comprises a connecting member 112. The cover 100 is configured to easily secure to the faucet 102 via the connecting member 112. In one embodiment, one end of the connecting member 112 is positioned within the cavity 108 and inserted via an opening or aperture 114 of the end wall 107 and another end is securely connected to the faucet 102 via a hook 118. The user could tighten the connecting member 112 to the faucet 102 using a fastener, for example, a bolt or nut. In one embodiment, the cover 100 further includes a closed cell foam 120, configured to prevent entering the cool weather conditions within the cavity 108, thereby protecting the faucet 102 from freezing in cool weather conditions.

Referring to FIG. 3, the cover 100 securely and removably positioned over the faucet 102 is disclosed. In one embodiment, the edges of the side walls 106 are compressed against the building wall so that the faucet 102 is positioned within the cavity 108 of the cover 100. The user could secure or attach the cover 100 to the faucet 102 by holding the one end of the connecting member 112, and aligning and securing the hook 118 at another end to the faucet 102. Further, the user could tighten the connecting member 112 to the faucet 102 via the fastener, for example, a bolt or nut at one end via a threading means. In one embodiment, the user could easily detach the cover 100 from the faucet 102 by loosening the fastener and retains the hook 118 from the faucet 102. In one embodiment, the edges of the side walls 106 include a closed cell foam 120. The closed cell foam 120 is configured to prevent entering the cool weather conditions within the cavity 108, thereby protecting the faucet 102 from freezing in cool weather conditions. In one embodiment, the closed cell foam 120 is made of a material, but not limited to, plastic and ethylene vinyl acetate (EVA) plastic. In one embodiment, the cover 100 further comprises an outer shell 136 to enhance the durability and extend the product life for several cold weather conditions to minimize expense.

Referring to FIG. 4, the heating system of the cover 100 is disclosed. In one embodiment, the heating system comprises one or more heating sources (122 and 124), for example, incandescent bulbs. The heating sources (122 and 124) are securely positioned on, but not limited to, the side walls 106 of the cover 100. In one embodiment, the heating sources (122 and 124) are electrically connected to the power supply via the power cord 126 with a polarized plug 128. The heating sources (122 and 124) are configured to provide sufficient heat within the cavity 108 of the cover 100 for the faucet 102 above freezing temperatures on a consistent basis, thereby preventing the faucet 102 from freezing in cool weather conditions. The heating sources (122 and 124) are typically 3,000-hour lifetime bulbs and are very inexpensive, allowing them to be exchanged every year before installing the cover 100 to enhance the reliability of operation.

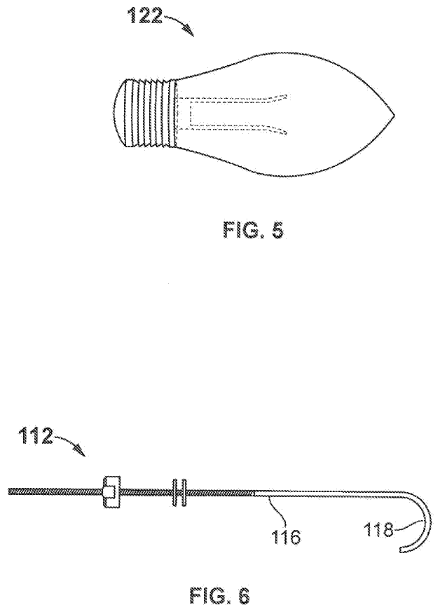

Referring to FIG. 5, the heat source 122 of the heating system of the cover 100 is disclosed. In one embodiment, the heat source 122 is, but not limited to, an incandescent bulb. The power rating of the heating source 122 is about, but not limited to, 7-watt. The heat sources (122 and 124) are low wattage incandescent bulbs, which are securely positioned within the cavity 108 of the cover 100 (shown in FIG. 1) to provide a thermal delta to the faucet 102 for preventing freezing. In one embodiment, the heat sources (122 and 124) are activated when the ambient temperature is below, but not limited to, 35° F. and shuts off when the ambient temperature is above, but not limited to, 45° F., thereby preventing the faucet 102 from freezing in cold weather conditions.

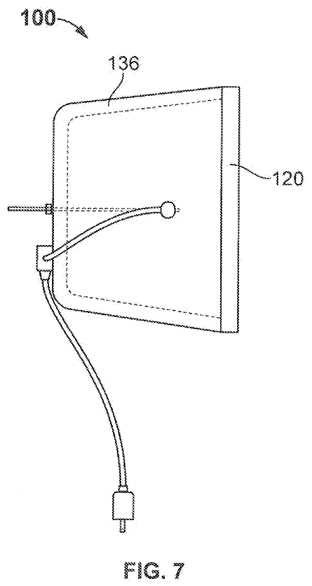

Referring to FIG. 6, the connecting member 112 of the cover 100 is disclosed. In one embodiment, the connecting member 112 is a threaded rod 116 with a hook 118. In one embodiment, one end of the threaded rod 116 includes a plurality of threads and another end includes the hook 118. The one end of the threaded rod is threaded to, but not limited to, 5-40 threads to accept the commercially available, a nylon wingnut. The other end of the threaded rod 116 is bent around, but not limited to, 1.0″ mandrel. The threaded rod 116 has a length of, but not limited to, 9.0″, which is sufficient to allow attachment to almost any existing exterior faucet configuration. In one embodiment, the threaded rod 116 includes a compressible rubber washer and a flat stainless-steel washer. The rubber washer makes a weather-resistant seal against an outer shell 136 (shown in FIG. 7) and the flat stainless-steel washer. The cover 100 is held onto the side of the dwelling and covers the faucet 102 using the connecting member 112. In one embodiment, the threaded rod 116 has a diameter of about, but not limited to, 0.125″. In one embodiment, the connecting member 112 is made of a material, but not limited to, a type 316 alloy stainless-steel material. The threaded rod 116 is bent at one end into the hook 118 with a 0.5″ internal radius so it will easily hook onto the faucet 102.

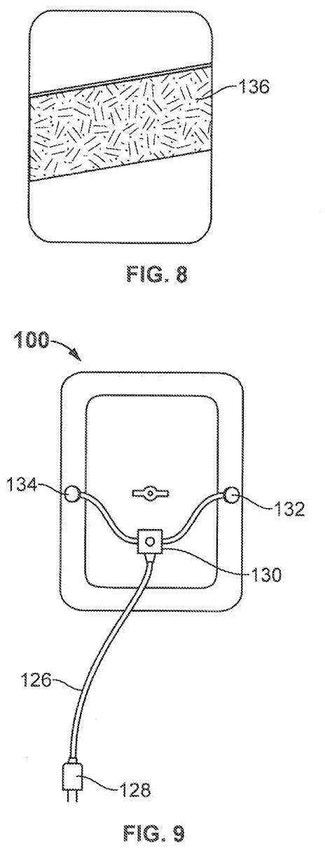

Referring to FIGS. 7-8, the cover 100 further includes an outer shell 136 is disclosed. In one embodiment, the outer shell 136 is made of a material, but not limited to, plastic. The outer shell 136 is configured to enhance the durability and extend the product life for several cold weather conditions to minimize expense. In a preferred embodiment, the outer shell 136 is a blow or rotationally molded from polypropylene plastic. This plastic is very durable, is highly resistant to household chemicals and UV degradation, and is typically used in this type of application. The cover 100 and bases are injection molded using, but not limited to, polypropylene plastic. In one embodiment, the outer shell 136 is, but not limited to, 6.75″ in tall and deep of about, but not limited to, 6.0″. The outer shell 136 is, but not limited to, 5.75″ in wide and a thickness of about, but not limited to, 0.05″. In one embodiment, an insulating foam is formed inside the outer shell 136 using, but not limited to, a molded polystyrene insulation and a form-in-place (FIP) polystyrene plastic. The insulating foam of the cover 100 is, but not limited to, 1.0″ in thickness and is approximately 80% air. The thermal transfer is very small through the insulating foam, thereby allowing the heat sources (122 and 124) (shown in FIG. 4) to produce sufficient heat at a very small energy cost.

In one embodiment, the cover 100 further includes a foam seal that is adhesively bonded to the bottom surface of the cover 100. The foam seal has a thickness of about, but not limited to, 0.75″ and has a wide of about, but not limited to, 1.0″. The foam seal is secured to the bottom of the cover 100 using very high energy contact cement. The foam seal could be supplied in optimum density to retain its shape while compressing to conform to the variations in the contour of the siding. The compression provides an airtight seal when attached to the faucet 102.

Referring to FIG. 9, the cover 100 further comprises a control element/device 130 is disclosed. In one embodiment, the control device 130 is a thermostatic control element and a temperature sensor. In one embodiment, the control device 130 is configured to control the operation of the heat sources (122 and 124) positioned within the cavity 108 of the cover 100. In one embodiment, the cover 100 is operated using 120 VAC power from household mains. The control device or thermostatic switch 130 may be of many different designs, but will turn on at 35° F., and allows the electric power to the heat sources (122 and 124). The control device or thermostatic switch 130 could turn off the heat sources (122 and 124) if the temperature is above freezing at, but not limited to, 45° F., thereby preventing the faucet 102 (shown in FIG. 2) from freezing in cold weather conditions. In one embodiment, the cover 100 is capable of maintaining a temperature approximately, but not limited to, 70° F. In one embodiment, the cover 100 further comprises one or more apertures (132 and 134) at, but not limited to, the side walls 106 and the end wall 107. The cover 100 provides space to make up all the connections and the control device 130 is extended via the aperture (132 and 134) and secured at the end wall 107 of the cover 100. The apertures (132 and 134) are molded and are sealed for protecting the faucet 102 from freezing in cold weather conditions. In one embodiment, the heat sources (122 and 124) are mounted on bases, which are molded inside the cover 100. The heat sources (122 and 124) are connected to the power supply via the power cord 126 with the polarized plug 128. In one embodiment, the length of the power cord 126 is, but not limited to, 18″ and secured to the cover 100 using a heavy-duty strain relief. In one embodiment, the cover 100 is operated at 120 VAC using 2-wire, 16-gauge wires wrapped with heavy-duty, exterior PVC jacketed extension cord. The wiring of the cover 100 is shielded within a plastic conduit. In one embodiment, the control device or thermostatic control 130 is mounted in a protective box on the exterior surface of the plastic shell 136 around the 1.0″ thick insulating foam box. In a preferred embodiment, the control device or thermostatic control 130 is adhesively bonded in place to make it water tight. The cover could operate at low current that less than 150 mA at 120 VAC so the heating expense will be low and it will protect the exterior faucets from freezing for a minimum cost.

In one embodiment, the heat source bases and the apertures (132 and 134) are thermally formed from, but not limited to, extruded polypropylene plastic pipe. In assembly, a make-up box, the conduits, and the bases are adhesively bonded in place and maintain their location while preventing any air and water leakages. The outer shell 136 of the cover 100 could be supplied in almost any vibrant color, so a distinctive color may be chosen to enhance the product recognition factor, which can dramatically improve the market adoption of the product. The cover 100 prevents water leaks inside the cavity 108 to protect the heat sources (122 and 124) and the connections from damages and in harsh conditions.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

I claim:

1. An outdoor faucet cover for insulating an associated outdoor faucet in freezing climates, comprising:
an insulator body defined by a first open end, a closed end opposite the open end, and at least one continuous sidewall between the closed end and the open end;
a cavity formed therein for receipt of the associated faucet;
a heating system adapted for providing sufficient heat to the insulator body to prevent the associated faucet from freezing;
wherein said insulator body is formed from at least one layer of weatherproof material;
a connecting means for securing said insulator body cavity securely around said associated faucet and any associated exposed water line of which said associated faucet is connected.

2. The insulator of claim 1, wherein said heating system further comprises:
at least one or more heating sources secured within one or more adjacent walls of said cavity of said insulator body;
a temperature sensor positioned for measuring ambient air temperature;
a thermostatic control element; and
a power source to enable said heating system.

3. The insulator of claim 2, wherein said heating system activates automatically when said temperature sensor is about 35° F. and shuts off when said temperature sensor is about 45° F.

4. The insulator of claim 3, wherein the thermostatic control element is positioned within an adjacent wall of said cavity of said insulator body.

5. The insulator of claim 3, wherein the thermostatic control element is positioned outside of said insulator body.

6. The insulator of claim 3, further comprising a foam seal adhesively bonded to the bottom surface of said open end of said insulator body such that said bottom surface is weather seal against the wall containing said outdoor faucet.

7. The insulator of claim 3, wherein said connecting means for securing said insulator body cavity securely around said associated faucet and any associated exposed water line of which said associated faucet is connected is selected from the group consisting of a hook, rod, or loop.

8. The insulator of claim 3, wherein said insulator body is contained within an outer insulated shell formed around said insulator body, said outer insulated shell having a first open end, a closed end opposite the open end, and at least one continuous sidewall between the closed end and the open end.

9. The insulator of claim 8, further comprising a foam seal adhesively bonded to the bottom surface of said open end of said outer insulated shell such that said outer insulated shell bottom surface is weather sealed against the wall containing said outdoor faucet.
